(19) United States
(12) Patent Application Publication
(10) Pub. No.: US 2025/0016801 A1
(43) Pub. Date: Jan. 9, 2025

(54) METHODS AND APPARATUSES FOR A SIDELINK FEEDBACK RESOURCE ALLOCATION MECHANISM

(71) Applicant: Lenovo (Beijing) Limited, Beijing (CN)

(72) Inventors: Xiaodong Yu, Beijing (CN); Zhennian Sun, Beijing (CN); Haipeng Lei, Beijing (CN); Xin Guo, Beijing (CN)

(73) Assignee: Lenovo (Beijing) Limited, Beijing (CN)

(21) Appl. No.: 18/711,507

(22) PCT Filed: Nov. 19, 2021
(86) PCT No.: PCT/CN2021/131895

§ 371 Date: May 17, 2024

(51) Int. Cl. H04W 72/25; H04L 1/1607; H04L 1/1812; H04L 5/00

(52) U.S. Cl. CPC H04W 72/25; H04L 1/1614; H04L 5/0055; H04L 1/1812

(57) ABSTRACT

Embodiments of the present application relate to methods and apparatuses for a sidelink feedback resource allocation mechanism. According to an embodiment of the present application, a user equipment (UE) includes a processor and a transceiver coupled to the processor; and the processor is configured: to receive, via the transceiver from a network node, sidelink configuration information regarding allocating one or more sidelink feedback resources for multiple carriers or multiple resource pools; and to transmit, via the transceiver over a sidelink, hybrid automatic repeat request (HARQ) feedback information on the one or more sidelink feedback resources.

### TECHNICAL FIELD

Embodiments of the present disclosure are related to wireless communication technology, and more particularly, related to methods and apparatuses for a sidelink feedback resource allocation mechanism.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12 (i.e., Rel-12), and enables a direct communication between proximal UEs, and data does not need to go through a base station (BS) or a core network.

5G and/or new radio (NR) networks are expected to increase network throughput, coverage, and robustness and reduce latency and power consumption. With the development of 5G and NR networks, various aspects need to be studied and developed to perfect the 5G and/or NR technology. Currently, details regarding a sidelink feedback resource allocation mechanism have not been specified yet.

### SUMMARY

Some embodiments of the present application also provide a user equipment (UE). The UE includes a processor and a transceiver coupled to the processor; and the processor is configured: to receive, via the transceiver from a network node, sidelink configuration information regarding allocating one or more sidelink feedback resources for multiple carriers or multiple resource pools; and to transmit, via the transceiver over a sidelink, hybrid automatic repeat request (HARQ) feedback information on the one or more sidelink feedback resources.

Some embodiments of the present application provide a method, which may be performed by a UE. The method includes: receiving, from a network node, sidelink configuration information regarding allocating one or more sidelink feedback resources for multiple carriers or multiple resource pools; and transmitting, over a sidelink, HARQ feedback information on the one or more sidelink feedback resources.

Some embodiments of the present application also provide a UE. The UE includes a processor and a transceiver coupled to the processor; and the processor is configured: to receive, via the transceiver from a network node, sidelink configuration information regarding allocating one or more sidelink feedback resources for multiple carriers or multiple resource pools; and to receive, via the transceiver over a sidelink, HARQ feedback information on the one or more sidelink feedback resources.

Some embodiments of the present application provide a method, which may be performed by a UE. The method includes: receiving, from a network node, sidelink configuration information regarding allocating one or more sidelink feedback resources for multiple carriers or multiple resource pools; and receiving, over a sidelink, HARQ feedback information on the one or more sidelink feedback resources.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a network node (e.g., a base station (BS)). The network node includes a processor and a transceiver coupled to the processor; and the processor is configured: to transmit, via the transceiver to a UE, sidelink configuration information regarding allocating one or more sidelink feedback resources for multiple carriers or multiple resource pools, wherein the one or more sidelink feedback resources are used to transmit HARQ feedback information.

Some embodiments of the present application provide a method, which may be performed by a network node (e.g., a BS). The method includes: transmitting, to a UE, sidelink configuration information regarding allocating one or more sidelink feedback resources for multiple carriers or multiple resource pools, wherein the one or more sidelink feedback resources are used to transmit HARQ feedback information.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary V2X communication system in accordance with some embodiments of the present application;

FIG. 2 illustrates an exemplary block diagram of an apparatus according to some embodiments of the present application;

FIG. 3 illustrates a flow chart of a method for transmitting HARQ feedback information according to some embodiments of the present application;

FIG. 4 illustrates a flow chart of a method for receiving HARQ feedback information according to some embodiments of the present application;

FIG. 5 illustrates a flow chart of separately (pre-) configuring a set of PRB(s) for PSFCH transmission or reception according to some embodiments of the present application;

FIG. 6 illustrates a flow chart of jointly (pre-) configuring a set of PRB(s) for PSFCH transmission or reception according to some embodiments of the present application;

FIG. 7 illustrates a further flow chart of jointly (pre-) configuring a set of PRB(s) for PSFCH transmission or reception according to some embodiments of the present application;

FIG. 8 illustrates an additional flow chart of jointly (pre-) configuring a set of PRB(s) for PSFCH transmission or reception according to some embodiments of the present application; and

FIG. 9 illustrates another flow chart of jointly (pre-) configuring a set of PRB(s) for PSFCH transmission or reception according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

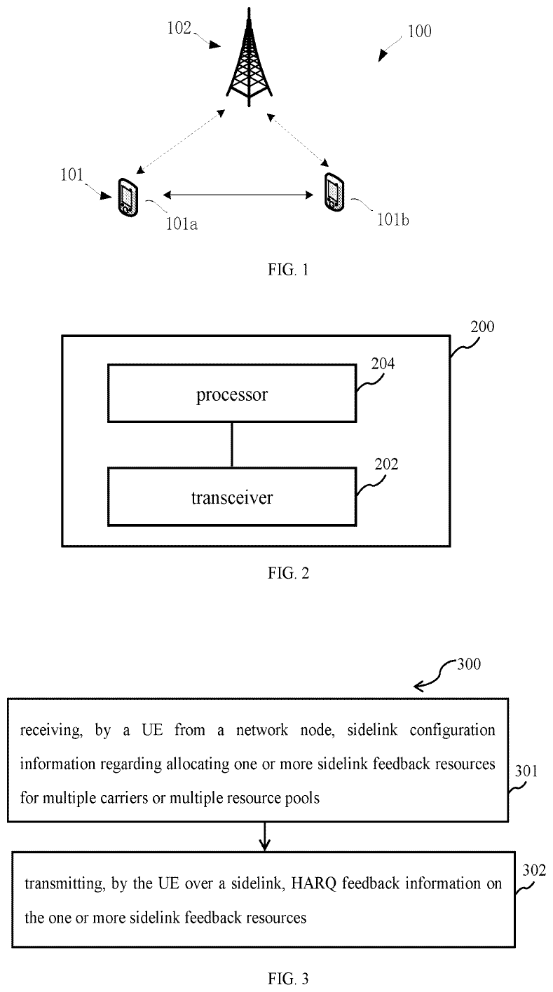

FIG. 1 illustrates an exemplary V2X communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, UE(s) 101 is pedestrian UE (P-UE or PUE) or cyclist UE. In some embodiments of the present application, UE(s) 101 includes wearable devices, such as smart watches, fitness bands, optical head-mounted displays, or the like. Moreover, UE(s) 101 may be referred to as a in subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface.

In some embodiments of the present application, each of UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in UE(s) 101 may be varied and not limited.

In a V2X communication system, a transmission UE may also be named as a transmitting UE, a Tx UE, or a sidelink Tx UE. A reception UE may also be named as a receiving UE, a Rx UE, or a sidelink Rx UE.

According to some embodiments of FIG. 1, UE 101a functions as a Tx UE, and UE 101b functions as a Rx UE. UE 101a may exchange V2X messages with UE 101b through a sidelink, for example, PC5 interface as defined in 3GPP TS 23.303. UE 101a may transmit information or data to other UE(s) within the V2X communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session. Alternatively, according to some other embodiments of FIG. 1, UE 101b functions as a Tx UE and transmits V2X messages, UE 101a functions as a Rx UE and receives the V2X messages from UE 101b.

Both UE 101a and UE 101b in the embodiments of FIG. 1 may transmit information to BS 102 and receive control information from BS 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL) and UE(s) 101 transmit data on the uplink (UL) using Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited or power sensitive UE.

Currently, a carrier aggregation (CA) feature was discussed for sidelink in last 3GPP RAN plenary meeting, and a specify mechanism is proposed to support a NR sidelink CA operation based on a LTE sidelink CA operation. For example, following objectives were proposed:
(1) Prioritize supporting LTE sidelink CA features for NR (i.e., sidelink carrier (re-) selection, synchronization of aggregated carriers, handling the limited capability, power control for simultaneous sidelink transmission, and/or a packet duplication).
(2) At least for FR1 licensed spectrum and ITS band. Whether or not to support sidelink CA for FR2 and/or unlicensed band is to be decided in RAN #98 after the relevant studies are done.
(3) The CA feature is backwards compatible in following regards:
   a) Rel-16 UEs can receive Rel-18 sidelink broadcast or groupcast transmissions with CA for the carriers on which they receive and transmit the corresponding sidelink HARQ feedback.
   b) Assuming this sidelink functionality would co-exist in the same resource pools as Rel-16 or Rel-17 functionalities (e.g., no change to reservations in sidelink control information (SCI), etc.)

In general, to consider HARQ feedback for CA, a UE may schedule multiple transmissions on multiple carriers, respectively, and the HARQ feedback for unicast or groupcast should be studied for below four possible scenarios:
(1) Component carrier (CC) 1 indicates a transmission in resource pool 1 or on CC1 and its associated feedback is transmitted in resource pool 1 or on CC1.
(2) CC1 indicates a transmission in resource pool 1 or on CC1 and its associated feedback is transmitted in resource pool 2 or on CC2. For example, in this scenario, there may be no feedback resource on CC1 or delay tolerance case.
(3) CC1 indicates a transmission in resource pool 2 or on CC2 and its associated feedback is transmitted in resource pool 1 or on CC1.
(4) CC1 indicates a transmission in resource pool 2 or on CC2 and its associated feedback is transmitted in resource pool 2 or on CC2.

Currently, there is no sidelink PSFCH resource allocation mechanism considered in a CA operation. One issue which needs to be addressed is that a current HARQ feedback resource was defined per resource pool on a carrier, while a sidelink feedback resource is not studied or defined for the other resource pool or carrier. Embodiments of the present application aim to solve the above-mentioned issue, e.g., in the above (2) scenario, in while CC1 indicates a transmission in resource pool 1 or on CC1 and its associated feedback is transmitted in resource pool 2 or on CC2.

Specifically, some embodiments of the present application separately (pre-) configure a set of physical resource blocks (PRBs) for PSFCH transmission or reception for the other resource pool or carrier. Some further embodiments of the present application jointly (pre-) configure a set of PRB(s) for PSFCH transmission or reception for multiple other resource pools or carriers with different offset values in frequency domain. Some other embodiments of the present application jointly (pre-) configure a set of PRB(s) for PSFCH transmission or reception for multiple other resource pools or carriers with different cyclic shift values. More details will be illustrated in the following text in combination with the appended drawings.

FIG. 2 illustrates an exemplary block diagram of an apparatus according to some embodiments of the present application. As shown in FIG. 2, the apparatus 200 may include at least one processor 204 and at least one transceiver 202 coupled to the processor 204. The at least one transceiver 202 may be a wired transceiver or a wireless transceiver. The apparatus 200 may be a UE or a network node (e.g., a BS).

Although in this figure, elements such as the at least one transceiver 202 and the processor 204 are described in the singular, the plural is contemplated unless a limitation to the singular is explicitly stated. In some embodiments of the present application, the transceiver 202 may be divided into two devices, such as a receiving circuitry and a transmitting circuitry. In some embodiments of the present application, the apparatus 200 may further include an input device, a memory, and/or other components.

In some embodiments of the present application, the apparatus 200 may be a UE (e.g., UE 101a or UE 101b as shown and illustrated in FIG. 1). The processor 204 of the UE may be configured to receive, via the transceiver 202 from a network node (e.g., BS 102 as shown and illustrated in FIG. 1), sidelink configuration information regarding allocating one or more sidelink feedback resources for multiple carriers or multiple resource pools; and to transmit, via the transceiver 202 over a sidelink, HARQ feedback information on the one or more sidelink feedback resources. According to some embodiments, the processor 204 of the UE may be configured to receive data via the sidelink, and the data is associated with the HARQ feedback information.

In some embodiments, the sidelink configuration information received via the transceiver 202 of the UE includes at least one of:
(1) An index indication of a carrier within the multiple carriers, and a set of indication information to indicate a sidelink feedback resource for the carrier. In an embodiment, the set of indication information indicates whether a set of resource blocks (RBs) includes the sidelink feedback resource for the carrier. For instance, the set of indication information may be a bitmap sequence. The set of RBs may be located in a physical sidelink feedback channel (PSFCH). The set of indication information is named as “the 1st set of indication information” in following text for simplicity.
(2) An index indication of a resource pool within the multiple resource pools, and a further set of indication information to indicate a sidelink feedback resource for the resource pool. In an embodiment, the further set of indication information indicates whether a further set of RBs includes the sidelink feedback resource for the resource pool. For instance, the further set of indication information may be a bitmap sequence. The further set of RBs may be located in a PSFCH. The further set of indication information is named as “the 2nd set of indication information” in following text for simplicity.

According to some embodiments, in a case that the 1st set of indication information is a bitmap sequence, a size of the bitmap sequence is associated with at least one of:
(1) a total number of RBs in the carrier within the multiple carriers; or
(2) a total number of resource block groups (RBGs) in the carrier; or
(3) a total number of sub-channels in the carrier.

According to some other embodiments, in a case that the 2nd set of indication information is a bitmap sequence, a size of the bitmap sequence is associated with at least one of:
(1) a total number of RBs in the resource pool within the multiple resource pools; or
(2) a total number of RBGs in the resource pool; or
(3) a total number of sub-channels in the resource pool.

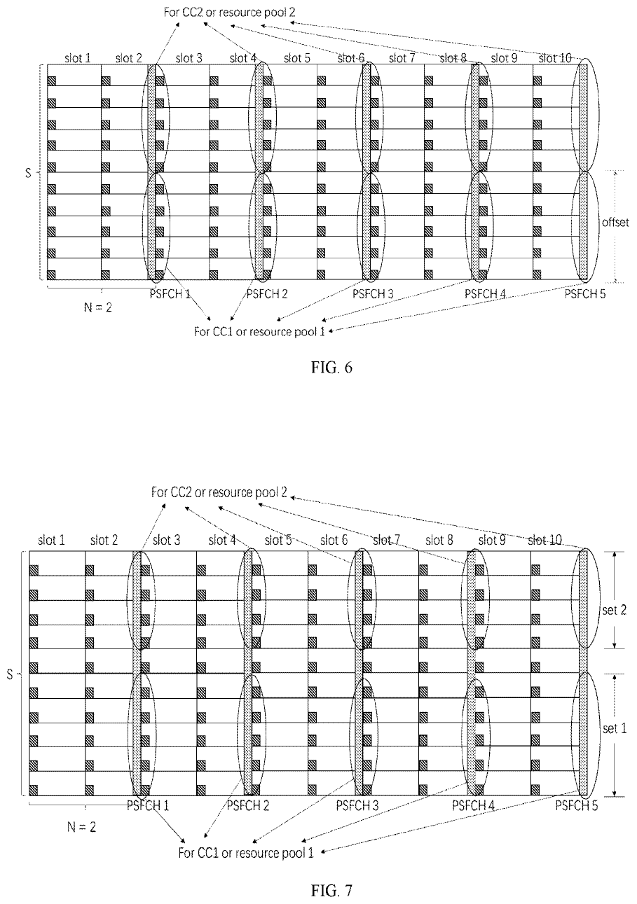

In some embodiments, the one or more sidelink feedback resources are located in a PSFCH. In some embodiments, the sidelink configuration information includes at least one of:
(1) Index information of a sidelink feedback resource for a carrier within the multiple carriers. This index information is named as “the 1st index information” in following text for simplicity. The sidelink feedback resource may be located in the PSFCH.
(2) Index information of a further sidelink feedback resource for a resource pool within the multiple resource pools. This index information is named as “the 2nd index information” in following text for simplicity. The further sidelink feedback resource may be located in the PSFCH. A specific example is described in embodiments of FIG. 6 as follows.

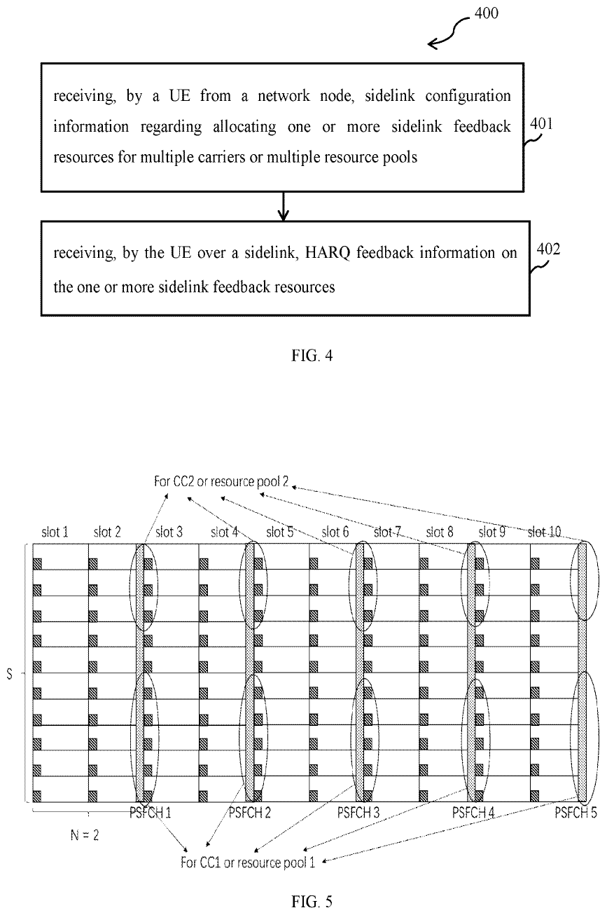

According to some embodiments, the 1st index information and/or the 2nd index information may be calculated based on one of: (1) an offset value from an index value of a lowest resource block (RB) in a frequency domain in the PSFCH; or (2) a offset value from an index value of a lowest resource block group (RBG) in the frequency domain in the PSFCH; or (3) an offset value from an index value of a lowest sub-channel in the frequency domain in the PSFCH. In an embodiment, at least one of these three offset values may be zero. That is, in this embodiment, the 1 st index information and/or the 2nd index information may be: (1) an index value of a lowest RB in a frequency domain in the PSFCH; or (2) an index value of a lowest resource block group (RBG) in the frequency domain in the PSFCH; or (3) an index value of a lowest sub-channel in the frequency domain in the PSFCH. A specific example is described in embodiments of FIG. 5 as follows. In a further embodiment, in a case that the sidelink configuration information allocates the one or more sidelink feedback resources for different carriers within multiple carriers or in a case that the sidelink configuration information allocates the one or more sidelink feedback resources for different resource pools within multiple resource pools, these three offset values may be different values.

According to some other embodiments, the 1st index information and/or the 2nd index information may be calculated based on at least one of:
(1) a source identifier (ID) (e.g., “K” described in the embodiments of FIG. 6) of a physical sidelink control channel (PSCCH) associated with the PSFCH;
(2) a source ID (e.g., “K” described in the embodiments of FIG. 6) of a physical sidelink shared channel (PSSCH) associated with the PSFCH;
(3) a value (e.g., “M” described in the embodiments of FIG. 6) which is related to a unicast and groupcast feedback option (e.g., groupcast HARQ feedback Option 1) or a further unicast and groupcast feedback option (e.g., groupcast HARQ feedback Option 2);
(4) a total number (e.g., “Z” described in the embodiments of FIG. 6) of physical resource blocks (PRBs) in each PRB of the PSFCH; or
(5) a total number (e.g., “Y” described in the embodiments of FIG. 6) of cyclic shift pairs in each PRB of the PSFCH.

In some further embodiments, the sidelink configuration information includes at least one of:
(1) A resource size of the sidelink feedback resource for the carrier within the multiple carriers. In an embodiment, this resource size is based on at least one of: 1) a total number of continuous RBs of the sidelink feedback resource in a frequency domain; 2) a total number of continuous RBGs of the sidelink feedback resource in the frequency domain; or 3) a total number of continuous sub-channels of the sidelink feedback resource in the frequency domain.
(2) A further resource size of the further sidelink feedback resource for the resource pool within the multiple resource pools. In an embodiment, this further resource size is based on at least one of: 1) a total number of continuous RBs of the further sidelink feedback resource in the frequency domain; 2) a total number of continuous RBGs of the further sidelink feedback resource in the frequency domain; or 3) a total number of continuous sub-channels of the further sidelink feedback resource in the frequency domain.

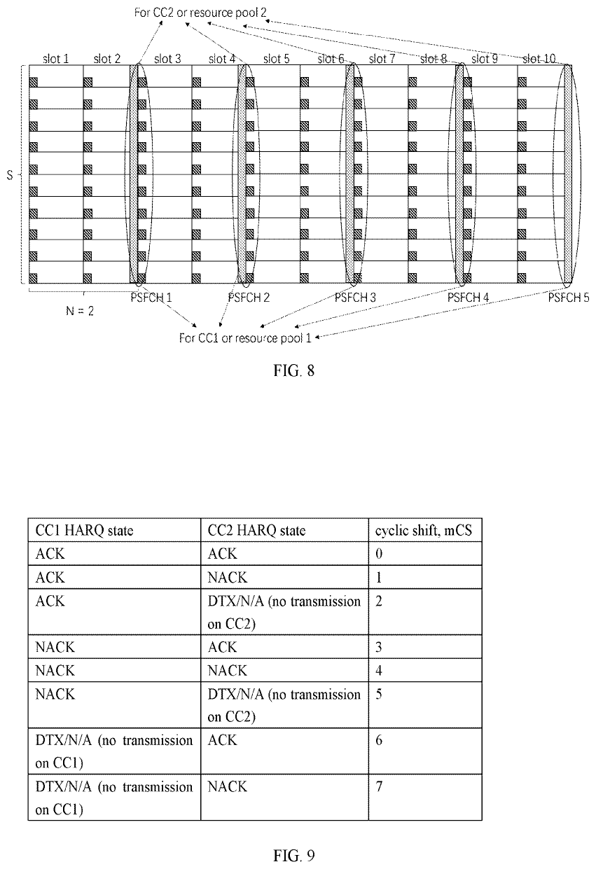

In some other embodiments, the sidelink configuration information includes at least one of:
(1) a cyclic shift related parameter (e.g., “mCS” for CC1 in embodiments of FIG. 8) corresponding to negative acknowledgement (NACK) feedback for a carrier within the multiple carriers;
(2) a cyclic shift related parameter (e.g., “mCS” for CC1 in embodiments of FIG. 8) corresponding to acknowledgement (ACK) feedback for the carrier within the multiple carriers;
(3) a cyclic shift related parameter (e.g., “mCS” for resource pool 1 in embodiments of FIG. 8) corresponding to NACK feedback for a resource pool within the multiple resource pools; or
(4) a cyclic shift related parameter (e.g., “mCS” for resource pool 1 in embodiments of FIG. 8) corresponding to ACK feedback for the resource pool within the multiple resource pools. A specific example is described in embodiments of FIG. 8 as follows.

According to some embodiments, the processor 204 of the UE may be configured: to determine, according to the sidelink configuration information, a cyclic shift related parameter for a carrier within the multiple carriers, in a case that “HARQ feedback information associated with data received in the carrier” is to be transmitted; and to transmit the HARQ feedback information in a PSFCH based on the determined cyclic shift related parameter. The cyclic shift related parameter corresponds to the HARQ feedback information. The HARQ feedback information may represent NACK or ACK. In an embodiment, in a case that “further HARQ feedback information associated with data received in a further carrier within the multiple carriers” is to be transmitted, the further HARQ feedback information is also transmitted in the PSFCH. The further HARQ feedback information may be transmitted based on a further cyclic shift related parameter for the further carrier. The further cyclic shift related parameter corresponds to the further HARQ feedback information. The further HARQ feedback information may represent NACK or ACK.

According to some other embodiments, the processor 204 of the UE may be configured: to determine, based on the configuration information, a cyclic shift related parameter for a resource pool within the multiple resource pools, in a case that “HARQ feedback information associated with data received in the resource pool” is to be transmitted; and to transmit the HARQ feedback information in a PSFCH based on the determined cyclic shift related parameter. The cyclic shift related parameter corresponds to the HARQ feedback information. The HARQ feedback information may represent NACK or ACK. In an embodiment, in a case that “further HARQ feedback information associated with data received in a further resource pool within the multiple resource pools” is to be transmitted, the further HARQ feedback information is also transmitted in the PSFCH. The further HARQ feedback information may be transmitted based on a further cyclic shift related parameter for the further resource pool. The further cyclic shift related parameter corresponds to the further HARQ feedback information. The further HARQ feedback information may represent NACK or ACK.

In some other embodiments, the sidelink configuration information includes at least one of:
(1) A cyclic shift related parameter for the multiple carriers (e.g., “mCS” for a pair of CC1 and CC2 HARQ states in embodiments of FIG. 9), which corresponds to “a combination of a HARQ feedback state of one carrier within the multiple carriers and a further HARQ feedback state of another carrier within the multiple carriers”. The HARQ feedback state or the further HARQ feedback state may represent one of: NACK, ACK, and discontinuous transmission (DTX). A specific example is described in embodiments of FIG. 9 as follows. In some embodiments, the processor 204 of the UE may be configured: to determine, according to the sidelink configuration information, a cyclic shift related parameter for the one carrier and the abovementioned another carrier within the multiple carriers, in a case that “the combination of the HARQ feedback state of the one carrier and the further HARQ feedback state of the abovementioned another carrier” is to be transmitted; and to transmit “the combination of the HARQ feedback state of the one carrier and the further HARQ feedback state of the abovementioned another carrier” in one PSFCH based on the determined cyclic shift related parameter.
(2) A cyclic shift related parameter for the multiple resource pools (e.g., “mCS” for a pair of resource pool 1 and resource pool 2 HARQ states in embodiments of FIG. 9), which corresponds to “a combination of a HARQ feedback state of one resource pool within the multiple resource pools and a further HARQ feedback state of another resource pool within the multiple resource pools”. The HARQ feedback state or the further HARQ feedback state may represent one of: NACK, ACK, and DTX. In some embodiments, the processor 204 of the UE may be configured: to determine, according to the sidelink configuration information, a cyclic shift related parameter for the one resource pool and the abovementioned another resource pool within the multiple resource pools, in a case that “the combination of the HARQ feedback state of the one resource pool and the further HARQ feedback state of the abovementioned another resource pool” is to be transmitted; and to transmit “the combination of the HARQ feedback state of the one resource pool and the further HARQ feedback state of the abovementioned another resource pool” in one PSFCH based on the determined cyclic shift related parameter.

In some embodiments of the present application, the apparatus 200 may be a UE (e.g., UE 101a or UE 101b as shown and illustrated in FIG. 1). The processor 204 of the UE may be configured: to receive, via the transceiver 202 from a network node, sidelink configuration information regarding allocating one or more sidelink feedback resources for multiple carriers or multiple resource pools; and to receive, via the transceiver 202 over a sidelink, HARQ feedback information on the one or more sidelink feedback resources.

According to some embodiments, the processor 204 of the UE may be configured to transmit data via the sidelink. The data may be associated with the HARQ feedback information.

In some embodiments, the sidelink configuration information received via the transceiver 202 of the UE includes at least one of:
(1) An index indication of a carrier within the multiple carriers, and a set of indication information to indicate a sidelink feedback resource for the carrier. In an embodiment, this set of indication information indicates whether a set of RBs includes the sidelink feedback resource for the carrier. For instance, this set of indication information may be a bitmap sequence. The set of RBs may be located in a PSFCH. This set of indication information is named as “the 1st set of indication information” in following text for simplicity.
(2) An index indication of a resource pool within the multiple resource pools, and a further set of indication information to indicate a sidelink feedback resource for the resource pool. In an embodiment, this further set of indication information indicates whether a further set of RBs includes the sidelink feedback resource for the resource pool. For instance, this further set of indication information may be a bitmap sequence. The further set of RBs may be located in a PSFCH. This further set of indication information is named as “the 2nd set of indication information” in following text for simplicity.

According to some embodiments, in a case that the 1st set of indication information is a bitmap sequence, a size of the bitmap sequence is associated with at least one of:
(1) a total number of RBs in the carrier within the multiple carriers; or
(2) a total number of RBGs in the carrier; or
(3) a total number of sub-channels in the carrier.

According to some other embodiments, in a case that the 2nd set of indication information is a bitmap sequence, a size of the bitmap sequence is associated with at least one of:
(1) a total number of RBs in the resource pool within the multiple resource pools; or
(2) a total number of RBGs in the resource pool; or
(3) a total number of sub-channels in the resource pool.

In some embodiments, the one or more sidelink feedback resources are located in a PSFCH. In some embodiments, the sidelink configuration information includes at least one of:
(1) Index information of a sidelink feedback resource for a carrier within the multiple carriers. This index information is named as “the 1st index information” in following text for simplicity. The sidelink feedback resource may be located in the PSFCH.
(2) Index information of a further sidelink feedback resource for a resource pool within the multiple resource pools. This index information is named as “the 2nd index information” in following text for simplicity. The further sidelink feedback resource may be located in the PSFCH. A specific example is described in embodiments of FIG. 6 as follows.

According to some embodiments, the 1st index information and/or the 2nd index information may be calculated based on one of: (1) an offset value from an index value of a lowest RB in a frequency domain in the PSFCH; or (2) a offset value from an index value of a lowest resource block group (RBG) in the frequency domain in the PSFCH; or (3) an offset value from an index value of a lowest sub-channel in the frequency domain in the PSFCH. In an embodiment, at least one of these three offset values may be zero. That is, in this embodiment, the 1st index information and/or the 2nd index information may be: (1) an index value of a lowest RB in a frequency domain in the PSFCH; or (2) an index value of a lowest resource block group (RBG) in the frequency domain in the PSFCH; or (3) an index value of a lowest sub-channel in the frequency domain in the PSFCH. A specific example is described in embodiments of FIG. 5 as follows. In a further embodiment, in a case that the sidelink configuration information allocates the one or more sidelink feedback resources for different carriers within multiple carriers or in a case that the sidelink configuration information allocates the one or more sidelink feedback resources for different resource pools within multiple resource pools, these three offset values may be different values.

According to some other embodiments, the 1st index information and/or the 2nd index information may be calculated based on at least one of:
(1) a source ID (e.g., “K” described in the embodiments of FIG. 6) of a physical sidelink control channel (PSCCH) associated with the PSFCH;
(2) a source ID (e.g., “K” described in the embodiments of FIG. 6) of a physical sidelink shared channel (PSSCH) associated with the PSFCH;
(3) a value (e.g., “M” described in the embodiments of FIG. 6) which is related to a unicast and groupcast feedback option (e.g., groupcast HARQ feedback Option 1) or a further unicast and groupcast feedback option (e.g., groupcast HARQ feedback Option 2);
(4) a total number (e.g., “Z” described in the embodiments of FIG. 6) of physical resource blocks (PRBs) in each PRB of the PSFCH; or
(5) a total number (e.g., “Y” described in the embodiments of FIG. 6) of cyclic shift pairs in each PRB of the PSFCH.

In some further embodiments, the sidelink configuration information includes at least one of:
(1) A resource size of the sidelink feedback resource for the carrier within the multiple carriers. In an embodiment, this resource size is based on at least one of: a total number of continuous RBs of the sidelink feedback resource in a frequency domain; a total number of continuous RBGs of the sidelink feedback resource in the frequency domain; or a total number of continuous sub-channels of the sidelink feedback resource in the frequency domain.
(2) A further resource size of the further sidelink feedback resource for the resource pool within the multiple resource pools. In an embodiment, this further resource size is based on at least one of: a total number of continuous RBs of the further sidelink feedback resource in the frequency domain; a total number of continuous RBGs of the further sidelink feedback resource in the frequency domain; or a total number of continuous sub-channels of the further sidelink feedback resource in the frequency domain.

In some other embodiments, the sidelink configuration information includes at least one of:
(1) a cyclic shift related parameter (e.g., “mCS” for CC1 in embodiments of FIG. 8) corresponding to NACK feedback for a carrier within the multiple carriers;
(2) a cyclic shift related parameter (e.g., “mCS” for CC1 in embodiments of FIG. 8) corresponding to ACK feedback for the carrier within the multiple carriers;
(3) a cyclic shift related parameter (e.g., “mCS” for resource pool 1 in embodiments of FIG. 8) corresponding to NACK feedback for a resource pool within the multiple resource pools; or
(4) a cyclic shift related parameter (e.g., “mCS” for resource pool 1 in embodiments of FIG. 8) corresponding to ACK feedback for the resource pool within the multiple resource pools. A specific example is described in embodiments of FIG. 8 as follows.

According to some embodiments, the processor 204 of the UE may be configured: to determine, according to the sidelink configuration information, a cyclic shift related parameter for a carrier within the multiple carriers; and to receive HARQ feedback information in a PSFCH based on the determined cyclic shift related parameter. The cyclic shift related parameter corresponds to the HARQ feedback information. The HARQ feedback information may represent NACK or ACK. In an embodiment, further HARQ feedback information associated with data transmitted in a further carrier within the multiple carriers is also received in the PSFCH. The further HARQ feedback information is received based on a further cyclic shift related parameter for the further carrier, and the further cyclic shift related parameter corresponds to the further HARQ feedback information. The further HARQ feedback information may represent NACK or ACK.

According to some other embodiments, the processor 204 of the UE may be configured: to determine, based on the configuration information, a cyclic shift related parameter for a resource pool within the multiple resource pools; and to receive HARQ feedback information in a PSFCH based on the determined cyclic shift related parameter. The cyclic shift related parameter corresponds to the HARQ feedback information. The HARQ feedback information may represent NACK or ACK. In an embodiment, further HARQ feedback information associated with data received in a further resource pool within the multiple resource pools is also received in the PSFCH. The further HARQ feedback information is received based on a further cyclic shift related parameter for the further resource pool. The further cyclic shift related parameter corresponds to the further HARQ feedback information. The further HARQ feedback information may represent NACK or ACK.

In some other embodiments, the sidelink configuration information includes at least one of:
(1) A cyclic shift related parameter for the multiple carriers (e.g., “mCS” for a pair of CC1 and CC2 HARQ states in embodiments of FIG. 9), which corresponds to “a combination of a HARQ feedback state of one carrier within the multiple carriers and a further HARQ feedback state of another carrier within the multiple carriers”. The HARQ feedback state or the further HARQ feedback state may represent one of: NACK, ACK, and DTX. A specific example is described in embodiments of FIG. 9 as follows. In some embodiments, the processor 204 of the UE may be configured: to determine, according to the sidelink configuration information, a cyclic shift related parameter for the one carrier and the abovementioned another carrier within the multiple carriers; and to receive “the combination of the HARQ feedback state of the one carrier and the further HARQ feedback state of the abovementioned another carrier” in one PSFCH based on the determined cyclic shift related parameter.
(2) A cyclic shift related parameter for the multiple resource pools (e.g., “mCS” for a pair of resource pool 1 and resource pool 2 HARQ states in embodiments of FIG. 9), which corresponds to “a combination of a HARQ feedback state of one resource pool within the multiple resource pools and a further HARQ feedback state of another resource pool within the multiple resource pools”. The HARQ feedback state or the further HARQ feedback state may represent one of: NACK, ACK, and DTX. In some embodiments, the processor 204 of the UE may be configured: to determine, according to the sidelink configuration information, a cyclic shift related parameter for the one resource pool and the abovementioned another resource pool within the multiple resource pools; and to receive “the combination of the HARQ feedback state of the one resource pool and the further HARQ feedback state of the abovementioned another resource pool” in one PSFCH based on the sixth cyclic shift related parameter.

In some embodiments of the present application, the apparatus 200 may be a network node (e.g., BS 102 as shown and illustrated in FIG. 1). The processor 204 of the network node may be configured to transmit, via the transceiver to a UE (e.g., UE 101a or UE 101b as shown and illustrated in FIG. 1), sidelink configuration information regarding allocating one or more sidelink feedback resources for multiple carriers or multiple resource pools. The one or more sidelink feedback resources may be used to transmit HARQ feedback information.

In some embodiments, the sidelink configuration information received via the transceiver 202 of the UE includes at least one of:
(1) An index indication of a carrier within the multiple carriers, and a set of indication information to indicate a sidelink feedback resource for the carrier. In an embodiment, this set of indication information indicates whether a set of RBs includes the sidelink feedback resource for the carrier. For instance, this set of indication information may be a bitmap sequence. The set of RBs may be located in a PSFCH. This set of indication information is named as “the 1st set of indication information” in following text for simplicity.
(2) An index indication of a resource pool within the multiple resource pools, and a further set of indication information to indicate a sidelink feedback resource for the resource pool. In an embodiment, this further set of indication information indicates whether a further set of RBs includes the sidelink feedback resource for the resource pool. For instance, this further set of indication information may be a bitmap sequence. The further set of RBs may be located in a PSFCH. This further set of indication information is named as “the 2nd set of indication information” in following text for simplicity.

According to some embodiments, in a case that the 1st set of indication information is a bitmap sequence, a size of the bitmap sequence is associated with at least one of:
(1) a total number of RBs in the carrier within the multiple carriers; or
(2) a total number of RBGs in the carrier; or
(3) a total number of sub-channels in the carrier.

According to some other embodiments, in a case that the 2nd set of indication information is a bitmap sequence, a size of the bitmap sequence is associated with at least one of:
(1) a total number of RBs in the resource pool within the multiple resource pools; or
(2) a total number of RBGs in the resource pool; or
(3) a total number of sub-channels in the resource pool.

According to some embodiments, the one or more sidelink feedback resources are located in a PSFCH. In some embodiments, the sidelink configuration information includes at least one of:
(1) Index information of a sidelink feedback resource for a carrier within the multiple carriers. This index information is named as “the 1st index information” in following text for simplicity. The sidelink feedback resource may be located in the PSFCH.
(2) Index information of a further sidelink feedback resource for a resource pool within the multiple resource pools. This index information is named as “the 2nd index information” in following text for simplicity. The further sidelink feedback resource may be located in the PSFCH. A specific example is described in embodiments of FIG. 6 as follows.

According to some embodiments, the 1st index information and/or the 2nd index information may be calculated based on one of: (1) an offset value from an index value of a lowest RB in a frequency domain in the PSFCH; or (2) a offset value from an index value of a lowest resource block group (RBG) in the frequency domain in the PSFCH; or (3) an offset value from an index value of a lowest sub-channel in the frequency domain in the PSFCH. In an embodiment, at least one of these three offset values may be zero. That is, in this embodiment, the 1st index information and/or the 2nd index information may be: (1) an index value of a lowest RB in a frequency domain in the PSFCH; or (2) an index value of a lowest resource block group (RBG) in the frequency domain in the PSFCH; or (3) an index value of a lowest sub-channel in the frequency domain in the PSFCH. A specific example is described in embodiments of FIG. 5 as follows. In a further embodiment, in a case that the sidelink configuration information allocates the one or more sidelink feedback resources for different carriers within the multiple carriers or in a case that the sidelink configuration information allocates the one or more sidelink feedback resources for different resource pools within the multiple resource pools, these three offset values may be different values.

According to some other embodiments, the 1st index information and/or the 2nd index information may be calculated based on at least one of:
(1) a source ID (e.g., “K” described in the embodiments of FIG. 6) of a physical sidelink control channel (PSCCH) associated with the PSFCH;
(2) a source ID (e.g., “K” described in the embodiments of FIG. 6) of a physical sidelink shared channel (PSSCH) associated with the PSFCH;
(3) a value (e.g., “M” described in the embodiments of FIG. 6) which is related to a unicast and groupcast feedback option (e.g., groupcast HARQ feedback Option 1) or a further unicast and groupcast feedback option (e.g., groupcast HARQ feedback Option 2);
(4) a total number (e.g., “Z” described in the embodiments of FIG. 6) of physical resource blocks (PRBs) in each PRB of the PSFCH; or
(5) a total number (e.g., “Y” described in the embodiments of FIG. 6) of cyclic shift pairs in each PRB of the PSFCH.

In some further embodiments, the sidelink configuration information includes at least one of:
(1) A resource size of the sidelink feedback resource for the carrier within the multiple carriers. In an embodiment, this resource size is based on at least one of: a total number of continuous RBs of the sidelink feedback resource in a frequency domain; a total number of continuous RBGs of the sidelink feedback resource in the frequency domain; or a total number of continuous sub-channels of the sidelink feedback resource in the frequency domain.
(2) A further resource size of the further sidelink feedback resource for the resource pool within the multiple resource pools. In an embodiment, this further resource size is based on at least one of: a total number of continuous RBs of the further sidelink feedback resource in the frequency domain; a total number of continuous RBGs of the further sidelink feedback resource in the frequency domain; or a total number of continuous sub-channels of the further sidelink feedback resource in the frequency domain.

In some other embodiments, the sidelink configuration information includes at least one of:
(1) a cyclic shift related parameter (e.g., “mCS” for CC1 in embodiments of FIG. 8) corresponding to NACK feedback for a carrier within the multiple carriers;
(2) a cyclic shift related parameter (e.g., “mCS” for CC1 in embodiments of FIG. 8) corresponding to ACK feedback for the carrier within the multiple carriers;
(3) a cyclic shift related parameter (e.g., “mCS” for resource pool 1 in embodiments of FIG. 8) corresponding to NACK feedback for a resource pool within the multiple resource pools; or
(4) a cyclic shift related parameter (e.g., “mCS” for resource pool 1 in embodiments of FIG. 8) corresponding to ACK feedback for the resource pool within the multiple resource pools. A specific example is described in embodiments of FIG. 8 as follows.

According to some embodiments, in a case that “HARQ feedback information associated with data received in a carrier within the multiple carriers” is to be transmitted, the HARQ feedback information is transmitted in a PSFCH based on a cyclic shift related parameter for the carrier. The cyclic shift related parameter may be determined according to the sidelink configuration information. The cyclic shift related parameter corresponds to the HARQ feedback information. The HARQ feedback information may represent NACK or ACK. In some embodiments, in a case that “further HARQ feedback information associated with data received in a further carrier within the multiple carriers” is to be transmitted, the further HARQ feedback information is also transmitted in the PSFCH. The further HARQ feedback information is transmitted based on a further cyclic shift related parameter for the further carrier. The further cyclic shift related parameter is determined according to the sidelink configuration information. The further cyclic shift related parameter corresponds to the further HARQ feedback information. The further HARQ feedback information may represent NACK or ACK.

According to some embodiments, in a case that “HARQ feedback information associated with data received in a resource pool within the multiple resource pools” is to be transmitted, the HARQ feedback information is transmitted in a PSFCH based on a cyclic shift related parameter for the resource pool. The cyclic shift related parameter is determined according to the sidelink configuration information. The cyclic shift related parameter corresponds to the HARQ feedback information. The HARQ feedback information may represent NACK or ACK. In some embodiments, in a case that “further HARQ feedback information associated with data received in a further resource pool within the multiple resource pools” is to be transmitted, the further HARQ feedback information is also transmitted in the PSFCH. The further HARQ feedback information is transmitted based on a further cyclic shift related parameter for the further resource pool. The further cyclic shift related parameter may be determined according to the sidelink configuration information. The further cyclic shift related parameter corresponds to the further HARQ feedback information. The further HARQ feedback information may represent NACK or ACK.

In some other embodiments, the sidelink configuration information includes at least one of:
(1) A cyclic shift related parameter for the multiple carriers (e.g., “mCS” for a pair of CC1 and CC2 HARQ states in embodiments of FIG. 9), which corresponds to “a combination of a HARQ feedback state of one carrier within the multiple carriers and a further HARQ feedback state of another carrier within the multiple carriers”. The HARQ feedback state or the further HARQ feedback state may represent one of: NACK, ACK, and DTX. A specific example is described in embodiments of FIG. 9 as follows. In some embodiments, in a case that “the combination of the HARQ feedback state of the one carrier and the further HARQ feedback state of the abovementioned another carrier” is to be transmitted, “the combination of the HARQ feedback state of the one carrier and the further HARQ feedback state of the abovementioned another carrier” may be transmitted in one PSFCH based on a cyclic shift related parameter for the one carrier and the abovementioned another carrier within the multiple carriers. The cyclic shift related parameter may be determined according to the sidelink configuration information.
(2) A cyclic shift related parameter for the multiple resource pools (e.g., “mCS” for a pair of resource pool 1 and resource pool 2 HARQ states in embodiments of FIG. 9), which corresponds to “a combination of a HARQ feedback state of one resource pool within the multiple resource pools and a further HARQ feedback state of another resource pool within the multiple resource pools”. The HARQ feedback state or the further HARQ feedback state may represent one of: NACK, ACK, and DTX. In some embodiments, in a case that “the combination of the HARQ feedback state of the one resource pool and the further HARQ feedback state of the abovementioned another resource pool” is to be transmitted, “the combination of the HARQ feedback state of the one resource pool and the further HARQ feedback state of the abovementioned another resource pool” may be transmitted in one PSFCH based on a further cyclic shift related parameter for the one resource pool and the abovementioned another resource pool within the multiple resource pools. The further cyclic shift related parameter may be determined according to the sidelink configuration information.

In some embodiments of the present application, the apparatus 200 may include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 204 interacting with the transceiver 202, so as to perform operations of the methods, e.g., as described in view of FIGS. 3 and 4.

FIG. 3 illustrates a flow chart of a method for transmitting HARQ feedback information according to some embodiments of the present application. The method 300 may be performed by a UE (e.g., UE 101 as shown and illustrated in FIG. 1). Although described with respect to a UE, it should be understood that other devices may also be configured to perform the method as shown and illustrated in FIG. 3.

In the exemplary method 300 as shown in FIG. 3, in operation 301, a UE (e.g., UE 101 as shown and illustrated in FIG. 1) receives, from a network node (e.g., BS 102 as shown and illustrated in FIG. 1), sidelink configuration information regarding allocating one or more sidelink feedback resources for multiple carriers or multiple resource pools. In operation 302, the UE transmits, over a sidelink, HARQ feedback information on the one or more sidelink feedback resources.

It is contemplated that the method illustrated in FIG. 3 may include other operation(s) not shown, for example, any operation(s) or embodiments of the sidelink configuration information regarding allocating one or more sidelink feedback resources for multiple carriers or multiple resource pools described with respect to FIGS. 2 and 4-9.

Details described in all other embodiments of the present application (for example, details regarding a sidelink feedback resource allocation mechanism) are applicable for the embodiments of FIG. 3. Moreover, details described in the embodiments of FIG. 3 are applicable for all embodiments of FIGS. 1, 2, and 4-9. It should be appreciated by persons skilled in the art that the sequence of the operations in exemplary procedure in the embodiments of FIG. 3 may be changed and some of the operations in exemplary procedure in the embodiments of FIG. 3 may be eliminated or modified, without departing from the spirit and scope of the disclosure.

FIG. 4 illustrates a flow chart of a method for receiving HARQ feedback information according to some embodiments of the present application. The embodiments of FIG. 4 may be performed by a UE (e.g., UE 101 as shown and illustrated in FIG. 1). Although described with respect to a UE, it should be understood that other devices may also be configured to perform the method as shown and illustrated in FIG. 4.

In the exemplary method 400 as shown in FIG. 4, in operation 401, a UE (e.g., UE 101a or UE 101b as shown and illustrated in FIG. 1) receives, from a network node (e.g., BS 102 as shown and illustrated in FIG. 1), sidelink configuration information regarding allocating one or more sidelink feedback resources for multiple carriers or multiple resource pools. In operation 402, the UE receives, over a sidelink, HARQ feedback information on the one or more sidelink feedback resources.

It is contemplated that the method illustrated in FIG. 4 may include other operation(s) not shown, for example, any operation(s) or embodiments of the sidelink configuration information regarding allocating one or more sidelink feedback resources for multiple carriers or multiple resource pools described with respect to FIGS. 2, 3, and 5-9.

Details described in all other embodiments of the present application (for example, details regarding a sidelink feedback resource allocation mechanism) are applicable for the embodiments of FIG. 4. Moreover, details described in the embodiments of FIG. 4 are applicable for all embodiments of FIGS. 1-3 and 5-9. It should be appreciated by persons skilled in the art that the sequence of the operations in exemplary procedure in the embodiments of FIG. 4 may be changed and some of the operations in exemplary procedure in the embodiments of FIG. 4 may be eliminated or modified, without departing from the spirit and scope of the disclosure.

According to RAN1 #106bis-e agreements, for allocating PSFCH resources in Scheme 2, at least a set of PRB(s) for PSFCH transmission or reception (sl-PSFCH-RB-Set) can be (pre-) configured separately from those for sidelink HARQ feedback. According to Rel-16 TS38.213 Section 16.3, for Scheme 2, an index of a PSFCH resource for inter-UE coordination information transmission is determined in the same way with at least following modification: P_ID is L1-Source ID indicated by UE-B's SCI; and M_ID is 0.

Based on the above background, some embodiments of the present application separately (pre-) configure a set of PRB(s) for PSFCH transmission or PSFCH reception for the other resource pool or carrier, in a scenario that CC1 indicates a transmission in resource pool 1 or on CC1 and its associated feedback is transmitted in resource pool 2 or on CC2. In these embodiments, resource pool configuration information (i.e., sidelink configuration information regarding allocating one or more sidelink feedback resources for multiple carriers or multiple resource pools) includes at least one field of:
(1) A set of indication information (e.g., higher layer signalling), to indicate whether a set of RB(s) has a HARQ feedback resource for another resource pool or another carrier.
   a) A resource pool is located in one carrier and is divided to multiple sub-channels in frequency domain, and each sub-channel includes some RBs (e.g., 10 RBs as shown in FIG. 5). A total number of RBs in each sub-channel may be determined based on a total number of RB(s) in the resource pool or the carrier. A set of indication information can be a sequence of 0 or 1 (e.g., in a bitmap manner). For instance, ‘1’ represents the corresponding RB(s) having a HARQ feedback resource, and ‘0’ represents the corresponding RB(s) having no HARQ feedback resource, and vice versa. The size of this sequence may be a total number of RB(s) in a slot.
      i. In an example, in a case that the resource pool includes 100 RBs, the indication information can be a sequence {x, x, x, x . . . x}, wherein a size of the sequence is 100, and a value of “x” is 0 or 1.
      ii. In a further example, in a case that the resource pool includes 10 RBGs, the indication information can be a sequence {x, x, x, x . . . x}, wherein a size of the sequence is 10, and a value of “x” is 0 or 1.
   b) The size of this bitmap sequence may be determined based on a total number of RBs in the resource pool or the carrier.
   c) The size of the indication information may be defined based on a total number of RBs, RBGs or sub-channels in the resource pool or the carrier.
(2) A resource pool or carrier index indication, to indicate the set of indication information is used for which resource pool or which carrier.

FIG. 5 illustrates a flow chart of separately (pre-) configuring a set of PRB(s) for PSFCH transmission or reception according to some embodiments of the present application.

As shown in FIG. 5, there are ten slots in time domain, i.e., slot 1 to slot 10. “S” indicates a total number of sub-channels in a slot as shown in FIG. 5. S=10 in the embodiments of FIG. 5. That is, each slot includes 10 sub-channels. For example, one sub-channel includes 10 RBs. “N” indicates a total number of PSSCH slots associated with a single PSFCH slot. N=2 in the embodiments of FIG. 5. In slot 1 to slot 10, there are five PSFCHs in total, i.e., PSFCH 1, PSFCH 2, PSFCH 3, PSFCH 4, and PSFCH 5. These five PSFCHs may carry HARQ feedback for CC1 or CC2 or for resource pool 1 or resource pool 2.

In the embodiments of FIG. 5, resource pool configuration information may include a set of indication information, to indicate whether a set of RB(s) has a HARQ feedback resource for CC1 or resource pool 1. For example, the set of indication information is a sequence {1,1,1 . . . , 1,1,0,0,0 . . . ,0,0}, wherein resource pool or carrier index=1. In this sequence, a size of {1,1,1,1 . . . , 1} is 50, which represents 50 RBs, with RB index “0˜49”, and a size of {0,0,0, . . . 0} is 50, which represents 50 RBs, with RB index “50˜99”. That is, in each of PSFCH 1 to PSFCH 5, the lowest 50 RBs are HARQ feedback resource for CC1 or resource pool 1.

In the embodiments of FIG. 5, resource pool configuration information may include a set of indication information, to indicate whether a set of RB(s) has a HARQ feedback resource for CC2 or resource pool 2. For example, the set of indication information is a sequence {0,0,0,0, . . . 0,0,0,1,1 . . . ,1}, wherein resource pool or carrier index=2. In this sequence, a size of {0,0,0, . . . 0} is 70, which represents 70 RBs, with RB index “0˜69”, and a size of {1,1,1,1 . . . , 1} is 30, which represents 30 RBs, with RB index “70˜99”. That is, in each of PSFCH 1 to PSFCH 5, the highest 30 RBs are HARQ feedback resource for CC2 or resource pool 2.

In other words, in the embodiments of FIG. 5, each PSFCH within PSFCH 1 to PSFCH 5 includes 100 RBs in frequency domain in total. HARQ feedback for CC1 or resource pool 1 is carried in sub-channels 1˜5 (i.e., the first 50 RBs in frequency domain) in each PSFCH. HARQ feedback for CC2 or resource pool 2 is carried in sub-channels 8˜10 (i.e., the last 30 RBs in frequency domain) in each PSFCH.

Details described in all other embodiments of the present application (for example, details regarding a sidelink feedback resource allocation mechanism) are applicable for the embodiments of FIG. 5. Moreover, details described in the embodiments of FIG. 5 are applicable for all the embodiments of FIGS. 1-4 and 6-9.

Currently, according to working assumptions of RAN1 #99, for a PSFCH candidate resource set with “Z” PRBs and “Y” cyclic shift pairs in each PRB, each PSFCH resource is indexed in the manner of frequency firstly and in the manner of cyclic shift secondly. PSFCH resource with the index ((K+M) mod (Z*Y)) is used for PSFCH transmission of a Rx UE. Wherein “K” is the L1 source ID of the associated PSCCH/PSSCH, “M” is 0 for unicast and groupcast HARQ feedback Option 1, and “M” is the member ID of the Rx UE for groupcast HARQ feedback Option 2.

As defined in 3GPP TS38.212, a UE determines an index of a PSFCH resource for a PSFCH transmission in response to a PSSCH reception as (P_{ID}+M_{ID}) modR_{PRB,CS}^{PSPCH}, where P_{ID} is a physical layer source ID provided by SCI format 2-A or 2-B [5, TS38.212] scheduling the PSSCH reception, and “M_{ID}” is the ID of the UE receiving the PSSCH as indicated by higher layers if the UE detects a SCI format 2-A with Cast type indicator field value of “01”; otherwise, “M_{ID}” is zero.

Based on the above background, some embodiments of the present application jointly (pre-) configure a set of PRB(s) for PSFCH transmission or reception for multiple other resource pools or carriers (e.g., difference PSFCH resources in the same set). In these embodiments, in a set of PSFCH resource(s) in a certain resource pool or a certain carrier, it may include PSFCH resource(s) for self-carrier and PSFCH resource(s) for other resource pool(s) or carrier(s). In particular, these embodiments may adopt following equations to calculate an index of a sidelink feedback resource for a carrier within multiple carriers or a resource pool within multiple resource pools.
(1) For self-carrier (CC1) or resource pool 1, a PSFCH resource with an index ((K+M+CC1_offset) mod (Z*Y)) is used for PSFCH transmission of a Rx UE. Here, CC1_offset may be (per-) configured to 0 by a network node.
(2) For carrier 2 (CC2) or resource pool 2, a PSFCH resource with an index ((K+M+CC1_offset+CC2_offset) mod (Z*Y)) is used for PSFCH transmission of the Rx UE. CC2_offset may be (per-) configured by the network node. And so on.
(3) For carrier n−1 (CCn−1) or resource pool n−1, a PSFCH resource with an index ((K+M+CC1_offset+CC2_offset+ . . . +CCn−1_offset) mod (Z*Y)) is used for PSFCH transmission of the Rx UE. CCn−1_offset may be (per-) configured by the network node.
(4) For carrier n (CCn) or resource pool n, a PSFCH resource with an index ((K+M+CC1_offset+CC2_offset+ . . . +CCn−1_offset+CCn_offset) mod (Z*Y)) is used for PSFCH transmission of the Rx UE. CCn_offset may be (per-) configured by the network node.

For example, an offset within “CC1_offset” to “CCn_offset” may be a RB index offset (e.g., the lowest RB index), a RBG index offset (e.g., the lowest RBG index), or a sub-channel index offset (e.g., the lowest sub-channel index).

In some embodiments, the offset can be a sub-channel (e.g., the lowest sub-channel index), or RBG offset value (e.g., the lowest RBG index). The offset can be a value, which is calculated based on the resource pool index or the carrier index. That is, the offset can be generated based on the resource pool index value or the carrier index value. For each carrier or each resource pool, the generated offset is different, and it can protect the feedback resource which is orthogonal in frequency or time domain for each carrier or each resource pool. A specific example is described in embodiments of FIG. 6 as follows.

In some further embodiments, the offset can be a value which is calculated based on “the lowest/start RB or RBG or sub-channel index” and “a size of a RB or RBG or sub-channel resource set (a total number of continuous RB(s) or RBG(s) or sub-channel(s) in the resource set)” in frequency domain. The lowest/start RB or RBG or sub-channel indicates the first RB or the first RBG or the first sub-channel in a resource set in frequency domain. A specific example is described in embodiments of FIG. 7 as follows.

In some other embodiments, the offset can be a value which is calculated based on “the lowest/start RB or RBG or sub-channel index” and “the highest/end RB or RBG or sub-channel index” in frequency domain. The lowest/start RB or RBG or sub-channel indicates the first RB or the first RBG or the first sub-channel in a resource set in frequency domain. The highest/end RB or RBG or sub-channel indicates the last RB or the last RBG or the last sub-channel in a resource set in frequency domain. A specific example is described in embodiments of FIG. 7 as follows.

FIG. 6 illustrates a flow chart of jointly (pre-) configuring a set of PRB(s) for PSFCH transmission or reception according to some embodiments of the present application.

The same as FIG. 5, in the embodiments of FIG. 6, each slot within ten slots in time domain (i.e., slot 1 to slot 10) includes 10 sub-channels (i.e., S=10 as shown in FIG. 6). Each sub-channel includes 10 RBs. N=2 in the embodiments of FIG. 6. Each PSFCH (i.e., PSFCH 1 to PSFCH 5) may carry HARQ feedback for CC1 or CC2 or HARQ feedback for resource pool 1 or resource pool 2.

In the embodiments of FIG. 6, CC1_offset is (per-) configured by a network node as 0. CC2_offset is (per-) configured by the network node as 50, i.e., “offset” for CC2 is 50 RBs as shown in FIG. 6. According to the abovementioned equations, for CC1 or resource pool 1, a PSFCH resource with the index ((K+M+CC1_offset) mod (Z*Y))=((K+M+0) mod (Z*Y)) is used for PSFCH transmission of a Rx UE. For CC2 or resource pool 2, a PSFCH resource with the index ((K+M+CC1_offset+CC2_offset) mod (Z*Y))=((K+M+50) mod (Z*Y)) is used for PSFCH transmission of the Rx UE. That is, in the embodiments of FIG. 6, each PSFCH within PSFCH 1 to PSFCH 5 includes 100 RBs in frequency domain in total. HARQ feedback for CC1 or resource pool 1 is carried in sub-channels 1˜5 (i.e., the first 50 RBs in frequency domain) in each PSFCH. HARQ feedback for CC2 or resource pool 2 is carried in sub-channels 6˜10 (i.e., the last 50 RBs in frequency domain) in each PSFCH.

FIG. 7 illustrates a further flow chart of jointly (pre-) configuring a set of PRB(s) for PSFCH transmission or reception according to some embodiments of the present application.

The same as FIGS. 5 and 6, in the embodiments of FIG. 7, each slot within ten slots in time domain (i.e., slot 1 to slot 10) includes 10 sub-channels (i.e., S=10 as shown in FIG. 7). Each sub-channel includes 10 RBs. N=2 in the embodiments of FIG. 7. Each PSFCH (i.e., PSFCH 1 to PSFCH 5) includes “set 1” to carry HARQ feedback for CC1 or resource pool 1 and “set 2” to carry HARQ feedback for CC2 or resource pool 2.

In some embodiments of FIG. 7, offsets of “set 1” and “set 2” are calculated based on “the lowest/start RB or RBG or sub-channel index” and “a size of a RB or RBG or sub-channel resource set” in frequency domain. In particular, “set 1” includes sub-channels 1˜5 (i.e., the first 50 RBs in frequency domain). The offset of “set 1” is 0, and a size of “set 1” is 5 sub-channels (i.e., 50 RBs) in frequency domain. “Set 2” includes sub-channels 7˜10 (i.e., the last 40 RBs in frequency domain). The offset of “set 2” is 6 sub-channels, and a size of “set 2” is 4 sub-channels (i.e., 40 RBs) in frequency domain.

In some other embodiments of FIG. 7, offsets of “set 1” and “set 2” are calculated based on “the lowest/start RB or RBG or sub-channel index” and “the highest/end RB or RBG or sub-channel index” in frequency domain. In particular, “set 1” includes sub-channels 1˜5 (i.e., the first 50 RBs in frequency domain). The lowest/start sub-channel index of “set 1” is 0, and the highest/end sub-channel index of “set 1” is 4 in frequency domain. “Set 2” includes sub-channels 7˜10 (i.e., the last 40 RBs in frequency domain). The lowest/start sub-channel index of “set 2” is 6, and the highest/end sub-channel index of “set 2” is 9 in frequency domain.

Details described in all other embodiments of the present application (for example, details regarding a sidelink feedback resource allocation mechanism) are applicable for the embodiments of FIGS. 6 and 7. Moreover, details described in the embodiments of FIGS. 6 and 7 are applicable for all the embodiments of FIGS. 1-5, 8 and 9.

As defined in 3GPP TS38.212, a UE determines an index of a PSFCH resource for a PSFCH transmission in response to a PSSCH reception, using a sequence associated with the resource pool, as (P_{ID}+M_{ID}) modR_{PRB,CS}^{PSFCH} where “P_{ID}” is a physical layer source ID provided by SCI format 0-2 [5, TS38.212] scheduling the PSSCH reception, “ ” M_{ID} is zero or “M_{ID}” is the identity of the UE receiving the PSSCH as indicated by higher layers. As defined in 3GPP TS38.211, a UE determines a “m_{cs}” value, for computing a value of cyclic shift “α” [4, TS38.211], from a cyclic shift pair of a PSFCH resource as in Table 1, which shows mapping of HARQ information bit values to a cyclic shift, from a cyclic shift pair, of a sequence for a PSFCH transmission.

TABLE 1

| HARQ Value | 0 (NACK) | 1 (ACK) |
|---|---|---|
| Sequence cyclic shift | First cyclic shift | Second cyclic shift |

According to 3GPP RAN1 agreements, for unicast or groupcast HARQ feedback Option 2, mCS=0 for NACK; and mCS=6 for ACK For groupcast HARQ feedback Option 1, mCS=0 for NACK; and mCS is not defined for ACK. For PSFCH resource indexing, following values of “m0” is sequentially used.
(1) mg=(0) for N_{CS}^{PSFCH}=1;
(2) mₒ={0,3} for N_{CS}^{PSFCH}=2;
(3) mₒ={0,2,4} for N_{CS}^{PSFCH}=3;
(4) mₒ={0, 1, 2,3, 4, 5} for N_{CS}^{PSFCH}=6; and
(5) N_{CS}^{PSFCH}=4 is not supported.

Based on the above background, some embodiments of the present application jointly (pre-) configure a set of PRB(s) for PSFCH transmission/reception for multiple other resource pools or carriers (e.g., difference cyclic shift values in the same set). In some embodiments, “CC1 or resource pool 1” and “CC2 or resource pool 2” share the same PSFCH resource set, while the cyclic shift of each carrier or each resource pool may be (pre)-configured, respectively. A specific example is described in embodiments of FIG. 8 as follows. In some other embodiments, “CC1 or resource pool 1” and “CC2 or resource pool 2” share the same PSFCH resource set, while CC1 and CC2 are jointly coded. A specific example is described in embodiments of FIG. 9 as follows.

FIG. 8 illustrates an additional flow chart of jointly (pre-) configuring a set of PRB(s) for PSFCH transmission or reception according to some embodiments of the present application. The same as FIGS. 5-7, in the embodiments of FIG. 8, each slot within ten slots in time domain (i.e., slot 1 to slot 10) includes 10 sub-channels (i.e., S=10 as shown in FIG. 8). Each sub-channel includes 10 RBs. N=2 in the embodiments of FIG. 8.

In the embodiments of FIG. 8, “CC1 or resource pool 1” and “CC2 or resource pool 2” share the same PSFCH resource set. As shown in FIG. 8, each PSFCH (i.e., PSFCH 1 to PSFCH 5) carries both “HARQ feedback for CC1 or resource pool 1” and “HARQ feedback for CC2 or resource pool 2”. The cyclic shift of each carrier or resource pool is (pre)-configured, respectively.

In some embodiments of FIG. 8, due to 12 cyclic shift values can be used for one RB, 6 carrier states can be supported for 6 carriers. For example, CC1: {0, 6}, CC2: {1, 7}, CC3: {2, 8}, CC4: {3, 9}, CC5: {4, 10}, CC6: {5, 11}. In some other embodiments of FIG. 8, due to 12 sequences can be carried on one RB, 12 mCS values can be configured for 6 resource pools. For example, resource pool 1: {0, 6}, resource pool 2: {1, 7}, resource pool 3: {2, 8}, resource pool 4: {3, 9}, resource pool 5: {4, 10}, resource pool 6: {5, 11}.

Specifically, for instance, in some embodiments of FIG. 8, for CC1 or resource pool 1:
(1) For unicast, groupcast HARQ feedback Option 2
   a) mCS=0 for NACK
   b) mCS=6 for ACK
(2) For groupcast HARQ feedback Option 1
   a) mCS=0 for NACK
   b) mCS is not defined for ACK

For CC2 or resource pool 2:
(1) For unicast, groupcast HARQ feedback Option 2
   a) mCS=3 for NACK
   b) mCS=9 for ACK
(2) For groupcast HARQ feedback Option 1
   a) mCS=3 for NACK
   b) mCS is not defined for ACK

In the embodiments of FIG. 8, for PSFCH resource indexing, following values of m0 is sequentially used.
(1) mₒ={0} for N_{CS}^{PSFCH}=1;
(2) mₒ={0,3} for N_{CS}^{PSFCH}=2;
(3) mₒ={0,2,4} for N_{CS}^{PSFCH}=3;
(4) mₒ={0, 1, 2, 3, 4, 5} for N_{CS}^{PSFCH}=6; and
(5) N_{CS}^{PSFCH}=4 is not supported.

Details described in all other embodiments of the present application (for example, details regarding a sidelink feedback resource allocation mechanism) are applicable for the embodiments of FIG. 8. Moreover, details described in the embodiments of FIG. 8 are applicable for all the embodiments of FIGS. 1-7 and 9.

FIG. 9 illustrates another flow chart of jointly (pre-) configuring a set of PRB(s) for PSFCH transmission or reception according to some embodiments of the present application.

In the embodiments of FIG. 9, ACK or NACK or DTX HARQ states are listed for CC1 and CC2 (paired), and cyclic shift “mCS” is configured for each pair of CC1 and CC2 HARQ states. As shown in FIG. 9, mCS=0 for “ACK on CC1” and “ACK for CC2”; mCS=1 for “ACK on CC1” and “NACK for CC2”; mCS=2 for “ACK on CC1” and “DTX/N/A (no transmission on CC2) for CC2”; mCS=3 for “NACK on CC1” and “ACK for CC2”; mCS=4 for “NACK on CC1” and “NACK for CC2”; mCS=5 for “NACK on CC1” and “DTX/N/A (no transmission on CC2) for CC2”; mCS=6 for “DTX/N/A (no transmission on CC2) on CC1” and “ACK for CC2”; and mCS=7 for “DTX/N/A (no transmission on CC2) on CC1” and “NACK for CC2”.

In the embodiments of FIG. 9, the mapping between CC1 and CC2 (paired) HARQ states and value of “mCS” can be flexible. That is, different values of cyclic shift “mCS” may be configured for each pair of CC1 and CC2 HARQ states.

In some other embodiments of FIG. 9, ACK or NACK or DTX HARQ states are listed for resource pool 1 and resource pool 2 (paired), and cyclic shift “mCS” is configured for each pair of resource pool 1 and resource pool 2 HARQ states. Different values of cyclic shift “mCS” may be configured for each pair of resource pool 1 and resource pool 2 HARQ states.

Details described in all other embodiments of the present application (for example, details regarding a sidelink feedback resource allocation mechanism) are applicable for the embodiments of FIG. 9. Moreover, details described in the embodiments of FIG. 9 are applicable for all the embodiments of FIGS. 1-8.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

What is claimed is:

1. A user equipment (UE) for wireless communication, comprising:
at least one memory; and
at least one processor coupled with the at least one memory and configured to cause the UE to:
receive sidelink configuration information regarding allocating one or more sidelink feedback resources for multiple carriers or multiple resource pools; and
transmit hybrid automatic repeat request (HARQ) feedback information on the one or more sidelink feedback resources.

2. The UE of claim 1, wherein the sidelink configuration information comprises at least one of:
a first index indication of a carrier within the multiple carriers, and a first set of indication information to indicate a sidelink feedback resource for the carrier; or
a second index indication of a resource pool within the multiple resource pools, and a second set of indication information to indicate a sidelink feedback resource for the resource pool.

3. The UE of claim 2, wherein one or more of:
the first set of indication information indicates whether a first set of resource blocks (RBs) includes the sidelink feedback resource for the carrier; or
the second set of indication information indicates whether a second set of RBs includes the sidelink feedback resource for the resource pool.

4. The UE of claim 2, wherein at least one of the first set of indication information or the second set of indication information is comprises a bitmap sequence.

5. The UE of claim 4, wherein one or more of:
in response to the first set of indication information comprising the bitmap sequence, a size of the bitmap sequence is associated with at least one of:
a total number of resource blocks (RBs) in the carrier;
a total number of resource block groups (RBGs) in the carrier; or
a total number of sub-channels in the carrier; or
in response to the second set of indication information comprising the bitmap sequence, the size of the bitmap sequence is associated with at least one of:
a total number of RBs in the resource pool;
a total number of RBGs in the resource pool; or
a total number of sub-channels in the resource pool.

6. The UE of claim 1, wherein the one or more sidelink feedback resources are located in a physical sidelink feedback channel (PSFCH).

7. The UE of claim 6, wherein the sidelink configuration information comprises at least one of:
first index information of a first sidelink feedback resource for a carrier within the multiple carriers; or
second index information of a second sidelink feedback resource for a resource pool within the multiple resource pools,
wherein both the first sidelink feedback resource and the second sidelink feedback resource are located in the PSFCH.

8. The UE of claim 7, wherein at least one of the first index information or the second index information is calculated based on at least one of:
a first offset value from an index value of a lowest resource block (RB) in a frequency domain in the PSFCH;
a second offset value from an index value of a lowest resource block group (RBG) in the frequency domain in the PSFCH; or
a third offset value from an index value of a lowest sub-channel in the frequency domain in the PSFCH.

9. The UE of claim 8, wherein in response to the carrier being a firstly configured carrier or the resource pool being a firstly configured resource pool, at least one of the first offset value, the second offset value, or the third offset value comprises zero.

10. The UE of claim 8, wherein in response to the sidelink configuration information allocating the one or more sidelink feedback resources for different carriers within the multiple carriers or for different resource pools within the multiple resource pools, the first offset value, the second offset value, and the third offset value comprise different values.

11. The UE of any of claim 6, wherein the sidelink configuration information comprises at least one of:
a first resource size of a first sidelink feedback resource for the carrier within the multiple carriers; or
a second resource size of the second sidelink feedback resource for the resource pool within the multiple resource pools.

12. The UE of claim 11, wherein:
the first resource size is based on at least one of:
a total number of continuous resource blocks (RBs) of the first sidelink feedback resource in a frequency domain;
a total number of continuous resource block groups (RBGs) of the first sidelink feedback resource in the frequency domain; or
a total number of continuous sub-channels of the first sidelink feedback resource in the frequency domain; and
the second resource size is based on at least one of:
a total number of continuous RBs of the second sidelink feedback resource in the frequency domain;
a total number of continuous RBGs of the second sidelink feedback resource in the frequency domain; or
a total number of continuous sub-channels of the second sidelink feedback resource in the frequency domain.

13. The UE of claim 6, wherein the sidelink configuration information comprises at least one of:
a cyclic shift related parameter corresponding to negative acknowledgement (NACK) feedback for a carrier within the multiple carriers;
a cyclic shift related parameter corresponding to acknowledgement (ACK) feedback for the carrier within the multiple carriers;
a cyclic shift related parameter corresponding to NACK feedback for a resource pool within the multiple resource pools; or
a cyclic shift related parameter corresponding to ACK feedback for the resource pool within the multiple resource pools.

14. A user equipment (UE) for wireless communication, comprising:
at least one memory; and
at least one processor coupled with the at least one memory and configured to cause the UE to:
receive sidelink configuration information regarding allocating one or more sidelink feedback resources for multiple carriers or multiple resource pools; and
receive hybrid automatic repeat request (HARQ) feedback information on the one or more sidelink feedback resources.

15. A network node for wireless communication, comprising:
at least one memory; and
at least one processor coupled with the at least one memory and configured to cause the network node to:
transmit sidelink configuration information regarding allocating one or more sidelink feedback resources for multiple carriers or multiple resource pools,
wherein the one or more sidelink feedback resources are configured to be used to transmit hybrid automatic repeat request (HARQ) feedback information.

16. A processor for wireless communication, comprising:
at least one controller coupled with at least one memory and configured to cause the processor to:
receive sidelink configuration information regarding allocating one or more sidelink feedback resources for multiple carriers or multiple resource pools; and
transmit hybrid automatic repeat request (HARQ) feedback information on the one or more sidelink feedback resources.

17. The processor of claim 16, wherein the sidelink configuration information comprises at least one of:
a first index indication of a carrier within the multiple carriers, and a first set of indication information to indicate a sidelink feedback resource for the carrier; or
a second index indication of a resource pool within the multiple resource pools, and a second set of indication information to indicate a sidelink feedback resource for the resource pool.

18. The processor of claim 17, wherein one or more of:
the first set of indication information indicates whether a first set of resource blocks (RBs) includes the sidelink feedback resource for the carrier; or
the second set of indication information indicates whether a second set of RBs includes the sidelink feedback resource for the resource pool.

19. The processor of claim 17, wherein at least one of the first set of indication information or the second set of indication information comprises a bitmap sequence.

20. The processor of claim 19, wherein one or more of:
in response to the first set of indication information being the bitmap sequence, a size of the bitmap sequence is associated with at least one of:
a total number of resource blocks (RBs) in the carrier;
a total number of resource block groups (RBGs) in the carrier; or
a total number of sub-channels in the carrier; or
in response to the second set of indication information being the bitmap sequence, the size of the bitmap sequence is associated with at least one of:
a total number of RBs in the resource pool;
a total number of RBGs in the resource pool; or
a total number of sub-channels in the resource pool.
